(19) United States
(12) Patent Application Publication
(10) Pub. No.: US 2022/0001673 A1
(43) Pub. Date: Jan. 6, 2022

(54) LOGIC CIRCUITRY PACKAGE

(71) Applicant: HEWLETT-PACKARD DEVELOPMENT COMPANY, L.P., Spring, TX (US)

(72) Inventors: Daryl Eugene ANDERSON, Convallis, OR (US); James Michael GARDNER, Convallis, OR (US); Christopher Hans BAKKER, Convallis, OR (US)

(73) Assignee: HEWLETT-PACKARD DEVELOPMENT COMPANY, L.P., Spring, TX (US)

(21) Appl. No.: 16/959,394

(22) PCT Filed: Oct. 25, 2019
(86) PCT No.: PCT/US2019/058185

§ 371 Date: Jun. 30, 2020

(51) Int. Cl. B41J 2/175

(52) U.S. Cl. CPC B41J 2/17566; B41J 2/17546; B41J 2029/3937; B41J 2002/17579; B41J 2/17526

(57) ABSTRACT

A replaceable print apparatus component includes a print material reservoir, a print material within the reservoir having a first print material level, and a logic circuitry package including an interface and a logic circuit. The logic circuit may receive, via the interface, a first calibration parameter and receive, via the interface, a first request corresponding to a first sensor ID associated with a second print material level above the first print material level. The logic circuit may transmit, via the interface, a first digital value in response to the first request and receive, via the interface, a second calibration parameter less than the first calibration parameter. The logic circuit may receive, via the interface, a second request corresponding to the first sensor ID, and transmit, via the interface, a second digital value in response to the second request. The second digital value is less than the first digital value.

### BACKGROUND

Subcomponents of apparatus may communicate with one another in a number of ways. For example, Serial Peripheral Interface (SPI) protocol, Bluetooth Low Energy (BLE), Near Field Communications (NFC) or other types of digital or analog communications may be used.

Some two-dimensional (2D) and three-dimensional (3D) printing systems include one or more replaceable print apparatus components, such as print material containers (e.g., inkjet cartridges, toner cartridges, ink supplies, 3D printing agent supplies, build material supplies etc.), inkjet printhead assemblies, and the like. In some examples, logic circuitry associated with the replaceable print apparatus component(s) communicate with logic circuitry of the print apparatus in which they are installed, for example communicating information such as their identity, capabilities, status and the like. In further examples, print material containers may include circuitry to execute one or more monitoring functions such as print material level sensing.

### BRIEF DESCRIPTION OF THE DRAWINGS

FIG. 1 illustrates one example of a printing system.

FIG. 2 illustrates one example of a replaceable print apparatus component.

FIG. 3 illustrates one example of a print apparatus.

FIGS. 4A-4E illustrate examples of logic circuitry packages and processing circuitry.

FIG. 5A illustrates one example arrangement of a fluid level sensor.

FIG. 5B illustrates a perspective view of one example of a print cartridge.

FIG. 6 illustrates one example of a memory of a logic circuitry package.

FIG. 7A is a graph illustrating one example of ink level sensor readings.

FIGS. 7B illustrates an example of a replaceable print apparatus component with an ink level sensor used to generate the ink level sensor readings of FIG. 7A.

FIGS. 8A-8C are flow diagrams illustrating example methods that may be carried out by a logic circuitry package.

FIG. 9 is a flow diagram illustrating another example method that may be carried out by a logic circuitry package.

FIGS. 10A and 10B are flow diagrams illustrating other example methods that may be carried out by a logic circuitry package.

FIG. 11 illustrates another example of a logic circuitry package.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

Some examples of applications described herein are in the context of print apparatus. Not all the examples, however, are limited to such applications, and at least some of the principles set out herein may be used in other contexts. The contents of other applications and patents cited in this disclosure are incorporated by reference.

In certain examples, Inter-integrated Circuit (I²C, or I²C, which notation is adopted herein) protocol allows at least one ‘master’ integrated circuit (IC) to communicate with at least one ‘slave’ IC, for example via a bus. I2C, and other communications protocols, communicate data according to a clock period. For example, a voltage signal may be generated, where the value of the voltage is associated with data. For example, a voltage value above X volts may indicate a logic “1” whereas a voltage value below X volts may indicate a logic “0”, where X is a predetermined numerical value. By generating an appropriate voltage in each of a series of clock periods, data can be communicated via a bus or another communication link.

Certain example print material containers have slave logic that utilize I2C communications, although in other examples, other forms of digital or analog communications could also be used. In the example of I2C communication, a master IC may generally be provided as part of the print apparatus (which may be referred to as the ‘host’) and a replaceable print apparatus component would comprise a ‘slave’ IC, although this need not be the case in all examples. There may be a plurality of slave ICs connected to an I2C communication link or bus (for example, containers of different colors of print agent). The slave IC(s) may include a processor to perform data operations before responding to requests from logic circuitry of the print system.

Communications between print apparatus and replaceable print apparatus components installed in the apparatus (and/or the respective logic circuitry thereof) may facilitate various functions. Logic circuitry within a print apparatus may receive information from logic circuitry associated with a replaceable print apparatus component via a communications interface, and/or may send commands to the replaceable print apparatus component logic circuitry, which may include commands to write data to a memory associated therewith, or to read data therefrom.

For example, logic circuitry associated with a replaceable print apparatus component may include an ink level sensor arranged inside a reservoir of the component. After the component is agitated, an ink film may coat the sensor above a level of the bulk ink until the ink settles. As will be described in more detail below, the presence of the ink film and the thickness of the ink film above the bulk ink may be measured by sensing the temperature of the ink after heating events of different lengths at a position on the sensor above the bulk ink. These measurements over time may be used to determine a profile of the ink, which may be compared to an expected profile, or to identify the bulk ink level prior to the ink settling.

In at least some of the examples described below, a logic circuitry package is described. The logic circuitry package may be associated with a replaceable print apparatus component, for example being internally or externally affixed thereto, for example at least partially within the housing, and is adapted to communicate data with a print apparatus controller via a bus provided as part of the print apparatus.

A ‘logic circuitry package’ as the term is used herein refers to one logic circuit, or more logic circuits that may be interconnected or communicatively linked to each other. Where more than one logic circuit is provided, these may be encapsulated as a single unit, or may be separately encapsulated, or not encapsulated, or some combination thereof. The package may be arranged or provided on a single substrate or a plurality of substrates. In some examples, the package may be directly affixed to a cartridge wall. In some examples, the package may include an interface, for example including pads or pins. The package interface may be intended to connect to a communication interface of the print apparatus component that in turn connects to a print apparatus logic circuit, or the package interface may connect directly to the print apparatus logic circuit. Example packages may be configured to communicate via a serial bus interface. Where more than one logic circuit is provided, these logic circuits may be connected to each other or to the interface, to communicate through the same interface.

In some examples, each logic circuitry package is provided with at least one processor and memory. In one example, the logic circuitry package may be, or may function as, a microcontroller or secure microcontroller. In use, the logic circuitry package may be adhered to or integrated with the replaceable print apparatus component. A logic circuitry package may alternatively be referred to as a logic circuitry assembly, or simply as logic circuitry or processing circuitry.

In some examples, the logic circuitry package may respond to various types of requests (or commands) from a host (e.g., a print apparatus). A first type of request may include a request for data, for example identification and/or authentication information. A second type of request from a host may be a request to perform a physical action, such as performing at least one measurement. A third type of request may be a request for a data processing action. There may be additional types of requests. In this disclosure, a command is also a type of request.

In some examples, there may be more than one address associated with a particular logic circuitry package, which is used to address communications sent over a bus to identify the logic circuitry package which is the target of a communication (and therefore, in some examples, with a replaceable print apparatus component). In some examples, different requests are handled by different logic circuits of the package. In some examples, the different logic circuits may be associated with different addresses. For example, cryptographically authenticated communications may be associated with secure microcontroller functions and a first I2C address, while other communications may be associated with a sensor circuit and a second and/or reconfigured I2C address. In certain examples, these other communications via the second and/or reconfigured address can be scrambled or otherwise secured, not using the key used for the secure microcontroller functions.

In at least some examples, a plurality of such logic circuitry packages (each of which may be associated with a different replaceable print apparatus component) may be connected to an I2C bus. In some examples, at least one address of the logic circuitry package may be an I2C compatible address (herein after, an I2C address), for example in accordance with an I2C protocol, to facilitate directing communications between master to slaves in accordance with the I2C protocol. For example, a standard I2C communications address may be 7 or 10 bits in length. In other examples, other forms of digital and/or analog communication can be used.

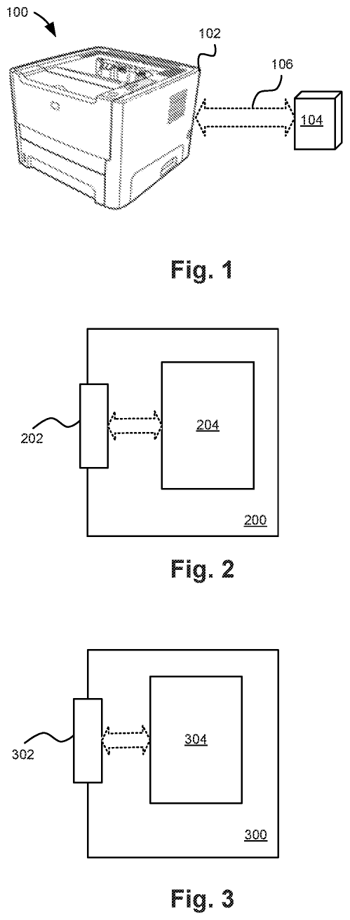

FIG. 1 illustrates one example of a printing system 100. The printing system 100 includes a print apparatus 102 in communication with logic circuitry associated with a replaceable print apparatus component 104 via a communications link 106. In some examples, the communications link 106 may include an I2C capable or compatible bus (herein after, an I2C bus). Although for clarity, the replaceable print apparatus component 104 is shown as external to the print apparatus 102, in some examples, the replaceable print apparatus component 104 may be housed within the print apparatus.

The replaceable print apparatus component 104 may include, for example, a print material container or cartridge (which could be a build material container for 3D printing, a liquid or dry toner container for 2D printing, or an ink or liquid print agent container for 2D or 3D printing), which may in some examples include a print head or other dispensing or transfer component. The replaceable print apparatus component 104 may, for example, contain a consumable resource of the print apparatus 102, or a component which is likely to have a lifespan which is less (in some examples, considerably less) than that of the print apparatus 102. Moreover, while a single replaceable print apparatus component 104 is shown in this example, in other examples, there may be a plurality of replaceable print apparatus components, for example including print agent containers of different colors, print heads (which may be integral to the containers), or the like. In other examples, the print apparatus components 104 could include service components, for example to be replaced by service personnel, examples of which could include print heads, toner process cartridges, or logic circuit package by itself to adhere to corresponding print apparatus component and communicate to a compatible print apparatus logic circuit.

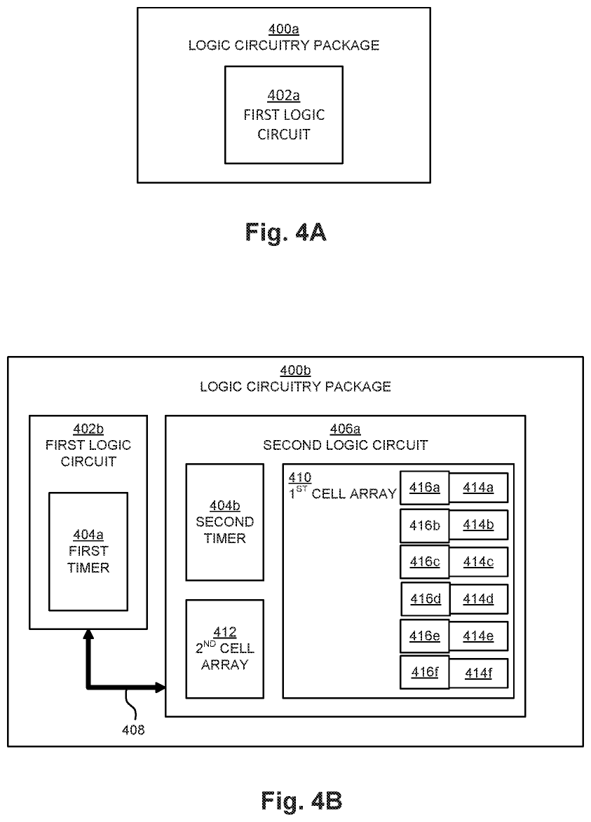

FIG. 2 illustrates one example of a replaceable print apparatus component 200, which may provide the replaceable print apparatus component 104 of FIG. 1. The replaceable print apparatus component 200 includes a data interface 202 and a logic circuitry package 204. In use of the replaceable print apparatus component 200, the logic circuitry package 204 decodes data received via the data interface 202. The logic circuitry may perform other functions as set out below. The data interface 202 may include an I2C or other interface. In certain examples, the data interface 202 may be part of the same package as the logic circuitry package 204.

In some examples, the logic circuitry package 204 may be further configured to encode data for transmission via the data interface 202. In some examples, there may be more than one data interface 202 provided. In some examples, the logic circuitry package 204 may be arranged to act as a ‘slave’ in I2C communications.

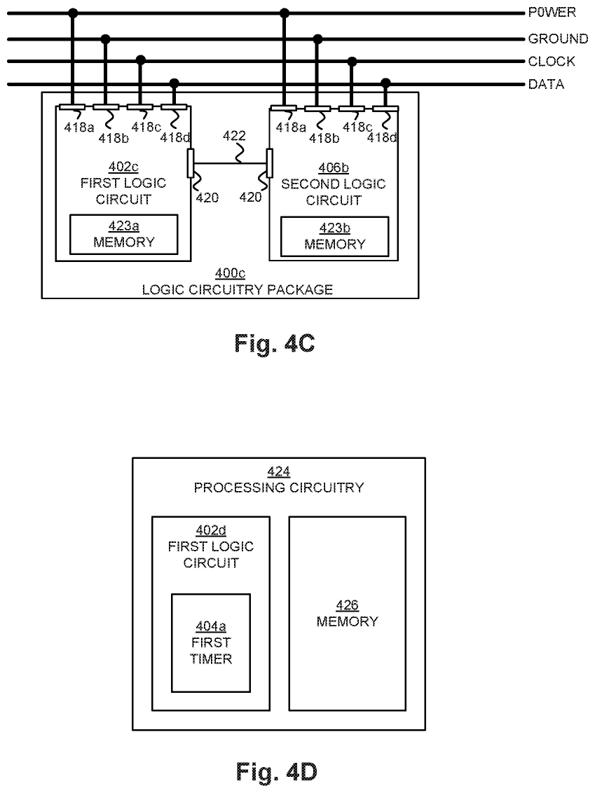

FIG. 3 illustrates one example of a print apparatus 300. The print apparatus 300 may provide the print apparatus 102 of FIG. 1. The print apparatus 300 may serve as a host for replaceable components. The print apparatus 300 includes an interface 302 for communicating with a replaceable print apparatus component and a controller 304. The controller 304 includes logic circuitry. In some examples, the interface 302 is an I2C interface.

In some examples, controller 304 may be configured to act as a host, or a master, in I2C communications. The controller 304 may generate and send commands to at least one replaceable print apparatus component 200, and may receive and decode responses received therefrom. In other examples the controller 304 may communicate with the logic circuitry package 204 using any form of digital or analog communication.

The print apparatus 102, 300 and replaceable print apparatus component 104, 200, and/or the logic circuitry thereof, may be manufactured and/or sold separately. In an example, a user may acquire a print apparatus 102, 300 and retain the apparatus 102, 300 for a number of years, whereas a plurality of replaceable print apparatus components 104, 200 may be purchased in those years, for example as print agent is used in creating a printed output. Therefore, there may be at least a degree of forwards and/or backwards compatibility between print apparatus 102, 300 and replaceable print apparatus components 104, 200. In many cases, this compatibility may be provided by the print apparatus 102, 300 as the replaceable print apparatus components 104, 200 may be relatively resource constrained in terms of their processing and/or memory capacity.

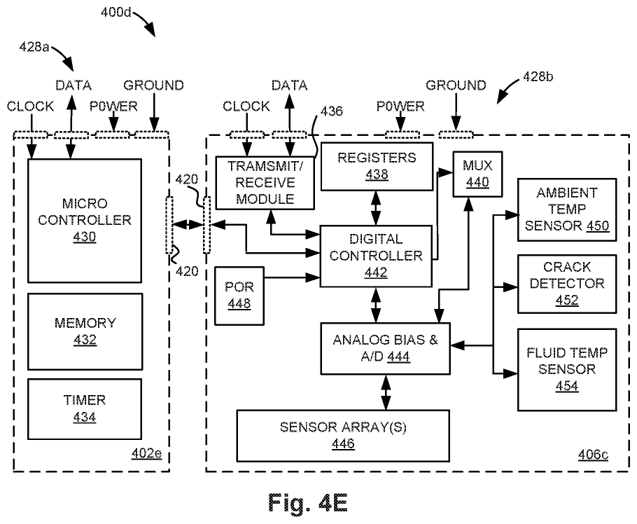

FIG. 4A illustrates one example of a logic circuitry package 400a, which may for example provide the logic circuitry package 204 described in relation to FIG. 2. The logic circuitry package 400a may be associated with, or in some examples affixed to and/or be incorporated at least partially within, a replaceable print apparatus component 200.

In some examples, the logic circuitry package 400a is addressable via a first address and includes a first logic circuit 402a, wherein the first address is an I2C address for the first logic circuit 402a. In some examples, the first address may be configurable. In other examples, the first address is a fixed address (e.g., “hard-wired”) intended to remain the same address during the lifetime of the first logic circuit 402a. The first address may be associated with the logic circuitry package 400a at and during the connection with the print apparatus logic circuit, outside of the time periods that are associated with a second address, as will be set out below. In example systems where a plurality of replaceable print apparatus components are to be connected to a single print apparatus, there may be a corresponding plurality of different first addresses. In certain examples, the first addresses can be considered standard I2C addresses for logic circuitry packages 400a or replaceable print components.

In some examples, the logic circuitry package 400a is also addressable via a second address. For example, the second address may be associated with different logic functions or, at least partially, with different data than the first address. In some examples, the second address may be associated with a different hardware logic circuit or a different virtual device than the first address. The hardware logic circuit can include analog sensor functions. In some examples, the logic circuitry package 400a may include a memory to store the second address (in some examples in a volatile manner). In some examples, the memory may include a programmable address memory register for this purpose. The second address may have a default second address while the second address (memory) field may be reconfigurable to a different address. For example, the second address may be reconfigurable to a temporary address by a second address command, whereby it is set (back) to the default second address after or at each time period command to enable the second address. For example, the second address may be set to its default address in an out-of-reset state whereby, after each reset, it is reconfigurable to the temporary (i.e., reconfigured) address.

In some examples, the package 400a is configured such that, in response to a first command indicative of a first time period sent to the first address (and in some examples a task), the package 400a may respond in various ways. In some examples, the package 400a is configured such that it is accessible via at least one second address for the duration of the time period. Alternatively or additionally, in some examples, the package may perform a task, which may be the task specified in the first command. In other examples, the package may perform a different task. The first command may, for example, be sent by a host such as a print apparatus in which the logic circuitry package 400a (or an associated replaceable print apparatus component) is installed. As set out in greater detail below, the task may include activating a heater or obtaining a sensor reading.

Further communication may be directed to memory addresses to be used to request information associated with these memory addresses. The memory addresses may have a different configuration than the first and second address of the logic circuitry package 400a. For example, a host apparatus may request that a particular memory register is read out onto the bus by including the memory address in a read command. In other words, a host apparatus may have a knowledge and/or control of the arrangement of a memory. For example, there may be a plurality of memory registers and corresponding memory addresses associated with the second address. A particular register may be associated with a value, which may be static or reconfigurable. The host apparatus may request that the register be read out onto the bus by identifying that register using the memory address. In some examples, the registers may include any or any combination of address register(s), parameter register(s) (for example to store gain and/or offset parameters), sensor identification register(s) (which may store an indication of a type of sensor), sensor reading register(s) (which may store values read or determined using a sensor), sensor number register(s) (which may store a number or count of sensors), version identity register(s), memory register(s) to store a count of clock cycles, memory register(s) to store a value indicative of a read/write history of the logic circuitry, or other registers.

FIG. 4B illustrates another example of a logic circuitry package 400b. In this example, the package 400b includes a first logic circuit 402b, in this example, including a first timer 404a, and a second logic circuit 406a, in this example, including a second timer 404b. While in this example, each of the first and second logic circuits 402b, 406a include its own timer 404a, 404b, in other examples, they may share a timer or reference at least one external timer. In a further example, the first logic circuit 402b and the second logic circuit 406a are linked by a dedicated signal path 408. In other examples, that are not the topic of FIG. 4B, a single integrated logic circuit may simulate the functions of the second logic circuit.

Back to FIG. 4B, in one example, the logic circuitry package 400b may receive a first command including two data fields. A first data field is a one byte data field setting a requested mode of operation. For example, there may be a plurality of predefined modes, such as a first mode, in which the logic circuitry package 400b is to ignore data traffic sent to the first address (for example, while performing a task), and a second mode in which the logic circuitry package 400b is to ignore data traffic sent to the first address and to transmit an enable signal to the second logic circuit 406a, as is further set out below. The first command may include additional fields, such as an address field and/or a request for acknowledgement.

The logic circuitry package 400b is configured to process the first command. If the first command cannot be complied with (for example, a command parameter is of an invalid length or value, or it is not possible to enable the second logic circuit 406a) , the logic circuitry package 400b may generate an error code and output this to a communication link to be returned to host logic circuitry, for example in the print apparatus.

If, however, the first command is validly received and can be complied with, the logic circuitry package 400b measures the duration of the time period included in the first command, for example utilizing the timer 404a. In some examples, the timer 404a may include a digital “clock tree”. In other examples, the timer 404a may include an RC circuit, a ring oscillator, or some other form of oscillator or timer. In yet other examples, the timer may include a plurality of delay circuits each of which is set to expire after a certain time period, whereby depending on the timer period indicated in a first command, the delay circuit is chosen.

In this example, in response to receiving a valid first command, the first logic circuit 402b enables the second logic circuit 406a and effectively disables the first address, for example by tasking the first logic circuit 402b with a processing task. In some examples, enabling the second logic circuit 406a includes sending, by the first logic circuit 402b, an activation signal to the second logic circuit 406a. In other words, in this example, the logic circuitry package 400b is configured such that the second logic circuit 406a is selectively enabled by the first logic circuit 402b. The first logic circuit 402b is configured to use the first timer 404a to determine the duration of the enablement, that is, to set the time period of the enablement.

In this example, the second logic circuit 406a is enabled by the first logic circuit 402b sending a signal via a signal path 408, which may or may not be a dedicated signal path 408, that is, dedicated to enable the second logic circuit 406a. In one example, the first logic circuit 402b may have a dedicated contact pin or pad connected to the signal path 408, which links the first logic circuit 402b and the second logic circuit 406a. In a particular example, the dedicated contact pin or pad may be a General Purpose Input/Output (a GPIO) pin of the first logic circuit 402b. The contact pin/pad may serve as an enablement contact of the second logic circuit 406a.

In this example, the second logic circuit 406a is addressable via at least one second address. In some examples, when the second logic circuit 406a is activated or enabled, it may have an initial, or default, second address, which may be an I2C address or have some other address format. The second logic circuit 406a may receive instructions from a master or host logic circuitry to reconfigure the initial second address to a temporary second address. In some examples, the temporary second address may be an address which is selected by the master or host logic circuitry. This may allow the second logic circuit 406a to be provided in one of a plurality of packages 400 on the same I2C bus which, at least initially, share the same initial second address. This shared, default, address may later be set to a specific temporary address by the print apparatus logic circuit, thereby allowing the plurality of packages to have different second addresses during their temporary use, facilitating communications to each individual package. At the same time, providing the same initial second address may have manufacturing or testing advantages.

In some examples, the second logic circuit 406a may include a memory. The memory may include a programmable address register to store the initial and/or temporary second address (in some examples in a volatile manner). In some examples, the second address may be set following, and/or by executing, an I2C write command. In some examples, the second address may be settable when the enablement signal is present or high, but not when it is absent or low. The second address may be set to a default address when an enablement signal is removed and/or on restoration of enablement of the second logic circuit 406a. For example, each time the enable signal over the signal path 408 is low, the second logic circuit 406a, or the relevant part(s) thereof, may be reset. The default address may be set when the second logic circuit 406a, or the relevant part(s) thereof, is switched out-of-reset. In some examples, the default address is a 7-bit or 10-bit identification value. In some examples, the default address and the temporary second address may be written in turn to a single, common, address register. For example, while the first address of the first logic circuit is different for each different associated print material (e.g., different color inks have different first addresses), the second logic circuits can be the same for the different print materials and have the same initial second address.

In the example illustrated in FIG. 4B, the second logic circuit 406a includes a first array 410 of cells and at least one second cell 412 or second array of second cells of a different type than the cells of the first array 410. In some examples, the second logic circuit 406a may include additional sensor cells of a different type than the cells of the first array 410 and the at least one second cell 412. Each of the plurality of sensor types may be identifiable by a different sensor ID, while each cell in a cell array of the same type may also be identifiable by sensor ID. The sensor ID may include both the sensor type ID to select the array or type and the sensor cell ID to select the cell in the selected type or array, whereby the latter may also be called “sub-”ID. The sensor IDs (including the sub-IDs) may include a combination of addresses and values, for example register addresses and values. The addresses of the sensor cell array ID and the sensor cell ID may be different. For example, an address selects a register that has a function to select a particular sensor or cell, and in the same transaction, the value selects the sensor or cell, respectively. Hence, the second logic circuit may include registers and multiplex circuitry to select sensor cells in response to sensor IDs. In examples where there is only one cell of a certain sensor type, one sensor ID may be sufficient to select that cell. At the same time, for that single sensor cell, different sensor “sub-”IDs will not affect the sensor cell selection because there is only one sensor cell. In this disclosure, sensor ID parameters are described. A sensor ID parameter may include a sensor ID. A sensor ID parameter may include a sensor type ID or a sensor cell ID. The same sensor ID (e.g., to select a sensor type) and different sensor sub-IDs (e.g., to select a sensor cell) may be used to select different sensor cells. The sensor ID parameters can include only the sensor sub-ID, for example where the sensor type has been previously set so that only the sensor cell needs to be selected.

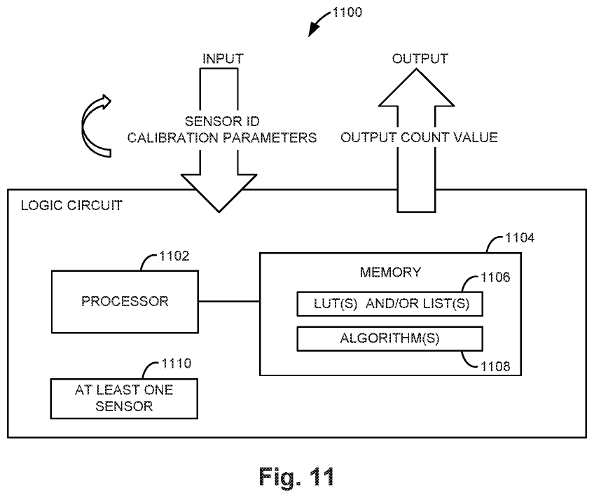

The first cells 416a-416f, 414a-414f and the at least one second cell 412 can include resistors. The first cells 416a-416f, 414a-414f and the at least one second cell 412 can include sensors. In one example, the first cell array 410 includes a print material level sensor and the at least one second cell 412 includes another sensor and/or another sensor array, such as an array of strain sensing cells. Further sensor types may include temperature sensors, resistors, diodes, crack sensors (e.g., crack sense resistors), etc. In this disclosure, different sensor types may also be referred to as different sensor classes. As mentioned, earlier, this disclosure encompasses alternative examples (e.g., mentioned with reference to FIG. 11) of logic circuitry packages without the described analog sensor cell arrays, whereby responses may be generated based on class parameters (i.e., sensor ID parameters) without using a physical sensor cell for generating the output.

In this example, the first cell array 410 includes a sensor configured to detect a print material level of a print supply, which may in some examples be a solid but in examples described herein is a liquid, for example, an ink or other liquid print agent. The first cell array 410 may include a series of temperature sensors (e.g., cells 414a-414f) and a series of heating elements (e.g., cells 416a-416f) , for example similar in structure and function as compared to the level sensor arrays described in WO2017/074342, WO2017/184147, and WO2018/022038. In this example, the resistance of a resistor cell 414 is linked to its temperature. The heater cells 416 may be used to heat the sensor cells 414 directly or indirectly using a medium. The subsequent behavior of the sensor cells 414 depends on the medium in which they are submerged, for example whether they are in liquid (or in some examples, encased in a solid medium) or in air. Those which are submerged in liquid/encased may generally lose heat quicker than those which are in air because the liquid or solid may conduct heat away from the resistor cells 414 better than air. Therefore, a liquid level may be determined based on which of the resistor cells 414 are exposed to the air, and this may be determined based on a reading of their resistance following (at least the start of) a heat pulse provided by the associated heater cell 416.

In some examples, each sensor cell 414 and heater cell 416 are stacked with one being directly on top of the other. The heat generated by each heater cell 416 may be substantially spatially contained within the heater element layout perimeter, so that heat delivery is substantially confined to the sensor cell 414 stacked directly above the heater cell 416. In some examples, each sensor cell 414 may be arranged between an associated heater cell 416 and the fluid/air interface.

In this example, the second cell array 412 includes a plurality of different cells that may have a different function such as different sensing function(s). For example, the first and second cell array 410, 412 may include different resistor types. Different cells arrays 410, 412 for different functions may be provided in the second logic circuit 406a. More than two different sensor types may be provided, for example three, four, five or more sensor types, may be provided, wherein each sensor type may be represented by one or more sensor cells. Certain cells or cell arrays may function as stimulators (e.g., heaters) or reference cells, rather than as sensors.

FIG. 4C illustrates an example of how a first logic circuit 402c and a second logic circuit 406b of a logic circuitry package 400c, which may have any of the attributes of the circuits/packages described above, may connect to an I2C bus and to each other. As is shown in the Figure, each of the circuits 402c, 406b has four pads (or pins) 418a-418d connecting to the Power, Ground, Clock, and Data lines of an I2C bus. In another example, four common connection pads are used to connect both logic circuits 402c, 406b to four corresponding connection pads of the print apparatus controller interface. It is noted that in some examples, instead of four connection pads, there may be fewer connection pads. For example, power may be harvested from the clock pad; an internal clock may be provided; or the package could be grounded through another ground circuit; so that, one or more of the pads may be omitted or made redundant. Hence, in different examples, the package could use only two or three interface pads and/or could include “dummy” pads.

Each of the circuits 402c, 406b has a contact pin 420, which are connected by a common signal line 422. The contact pin 420 of the second circuit serves as an enablement contact thereof.

In this example, each of the first logic circuit 402c and the second logic circuit 406b include a memory 423a, 423b. The memory 423a of the first logic circuit 402c stores information including cryptographic values (for example, a cryptographic key and/or a seed value from which a key may be derived) and identification data and/or status data of the associated replaceable print apparatus component. In some examples, the memory 423a may store data representing characteristics of the print material, for example, any part, or any combination of its type, color, color map, recipe, batch number, age, etc. The first logic circuit 402c may be, or function as, a microcontroller or secure microcontroller.

In this example, memory 423b of the second logic circuit 406b includes a programmable address register to contain an initial address of the second logic circuit 406b when the second logic circuit 406b is first enabled and to subsequently contain a new (temporary) second address (in some examples in a volatile manner) after that new second address has been communicated by the print apparatus. The new, e.g., temporary, second address may be programmed into the second address register after the second logic circuit 406b is enabled, and may be effectively erased or replaced at the end of an enablement period. In some examples, the memory 423b may further include programmable registers to store any, or any combination of a read/write history data, cell (e.g., resistor or sensor) count data, Analog to Digital converter data (ADC and/or DAC), and a clock count, in a volatile or non-volatile manner. The memory 423b may also receive and/or store calibration parameters, such as offset and gain parameters. Use of such data is described in greater detail below. Certain characteristics, such as cell count or ADC or DAC characteristics, could be derivable from the second logic circuit instead of being stored as separate data in the memory.

In one example, the memory 423b of the second logic circuit 406b stores any or any combination of an address, for example the second I2C address; an identification in the form of a revision ID; and the index number of the last cell (which may be the number of cells less one, as indices may start from 0), for example for each of different cell arrays or for multiple different cell arrays if they have the same number of cells.

In use of the second logic circuit 406b, in some operational states, the memory 423b of the second logic circuit 406 may store any or any combination of timer control data, which may enable a timer of the second circuit, and/or enable frequency dithering therein in the case of some timers such as ring oscillators; a dither control data value (to indicate a dither direction and/or value); and a timer sample test trigger value (to trigger a test of the timer by sampling the timer relative to clock cycles measureable by the second logic circuit 406b) .

While the memories 423a, 423b are shown as separate memories here, they could be combined as a shared memory resource, or divided in some other way. The memories 423a, 423b may include a single or multiple memory devices, and may include any or any combination of volatile memory (e.g., DRAM, SRAM, registers, etc.) and non-volatile memory (e.g., ROM, EEPROM, Flash, EPROM, memristor, etc.).

While one package 400c is shown in FIG. 4C, there may be a plurality of packages with a similar or a different configuration attached to the bus.

FIG. 4D illustrates an example of processing circuitry 424 which is for use with a print material container. For example, the processing circuitry 424 may be affixed or integral thereto. As already mentioned, the processing circuitry 424 may include any of the features of, or be the same as, any other logic circuitry package of this disclosure.

In this example, the processing circuitry 424 includes a memory 426 and a first logic circuit 402d which enables a read operation from memory 426. The processing circuitry 424 is accessible via an interface bus of a print apparatus in which the print material container is installed and is associated with a first address and at least one second address. The bus may be an I2C bus. The first address may be an I2C address of the first logic circuit 402d. The first logic circuit 402d may have any of the attributes of the other examples circuits/packages described in this disclosure.

The first logic circuit 402d is adapted to participate in authentication of the print materials container by a print apparatus in which the container is installed. For example, this may include a cryptographic process such as any kind of cryptographically authenticated communication or message exchange, for example based on a key stored in the memory 426, and which can be used in conjunction with information stored in the printer. In some examples, a printer may store a version of a key which is compatible with a number of different print material containers to provide the basis of a ‘shared secret’. In some examples, authentication of a print material container may be carried out based on such a shared secret. In some examples, the first logic circuit 402d may participate in a message to derive a session key with the print apparatus and messages may be signed using a message authentication code based on such a session key. Examples of logic circuits configured to cryptographically authenticate messages in accordance with this paragraph are described in U.S. Pat. publication No. 9,619,663.

In some examples, the memory 426 may store data including: identification data and read/write history data. In some examples, the memory 426 further includes cell count data (e.g., sensor count data) and clock count data. Clock count data may indicate a clock speed of a first and/or second timer 404a, 404b (i.e., a timer associated with the first logic circuit or the second logic circuit). In some examples, at least a portion of the memory 426 is associated with functions of a second logic circuit, such as a second logic circuit 406a as described in relation to FIG. 4B above. In some examples, at least a portion of the data stored in the memory 426 is to be communicated in response to commands received via the second address, for example the earlier mentioned initial or reconfigured/temporary second address. In some examples, the memory 426 includes a programmable address register or memory field to store a second address of the processing circuitry (in some examples in a volatile manner). The first logic circuit 402d may enable read operation from the memory 426 and/or may perform processing tasks.

The memory 426 may, for example, include data representing characteristics of the print material, for example any or any combination of its type, color, batch number, age, etc. The memory 426 may, for example, include data to be communicated in response to commands received via the first address. The processing circuitry may include a first logic circuit to enable read operations from the memory and perform processing tasks.

In some examples, the processing circuitry 424 is configured such that, following receipt of the first command indicative of a task and a first time period sent to the first logic circuit 402d via the first address, the processing circuitry 424 is accessible by at least one second address for a duration of the first time period. Alternatively or additionally, the processing circuitry 424 may be configured such that in response to a first command indicative of a task and a first time period sent to the first logic circuit 402d addressed using the first address, the processing circuitry 424 is to disregard (e.g., ‘ignore’ or ‘not respond to’) I2C traffic sent to the first address for substantially the duration of the time period as measured by a timer of the processing circuitry 424 (for example a timer 404a, 404b as described above). In some examples, the processing circuitry may additionally perform a task, which may be the task specified in the first command. The term ‘disregard’ or ‘ignore’ as used herein with respect to data sent on the bus may include any or any combination of not receiving (in some examples, not reading the data into a memory), not acting upon (for example, not following a command or instruction) and/or not responding (i.e., not providing an acknowledgement, and/or not responding with requested data).

The processing circuitry 424 may have any of the attributes of the logic circuitry packages 400 described herein. In particular, the processing circuitry 424 may further include a second logic circuit wherein the second logic circuit is accessible via the second address. In some examples, the second logic circuit may include at least one sensor which is readable by a print apparatus in which the print material container is installed via the second address. In some examples, such a sensor may include a print materials level sensor. In an alternative example, the processing circuitry 424 may include a single, integral logic circuit, and one or more sensors of one or more types.

FIG. 4E illustrates another example of a first logic circuit 402e and second logic circuit 406c of a logic circuitry package 400d, which may have any of the attributes of the circuits/packages of the same names described herein, which may connect to an I2C bus via respective interfaces 428a, 428b and to each other. In one example the respective interfaces 428a, 428b are connected to the same contact pad array, with only one data pad for both logic circuits 402e, 406c, connected to the same serial I2C bus. In other words, in some examples, communications addressed to the first and the second address are received via the same data pad.

In this example, the first logic circuit 402e includes a microcontroller 430, a memory 432, and a timer 434. The microcontroller 430 may be a secure microcontroller or customized integrated circuitry adapted to function as a microcontroller, secure or non-secure.

In this example, the second logic circuit 406c includes a transmit/receive module 436, which receives a clock signal and a data signal from a bus to which the package 400d is connected, data registers 438, a multiplexer 440, a digital controller 442, an analog bias and analog to digital converter 444, at least one sensor or cell array 446 (which may in some examples include a level sensor with one or multiple arrays of resistor elements), and a power-on reset (POR) device 448. The POR device 448 may be used to allow operation of the second logic circuit 406c without use of a contact pin 420.

The analog bias and analog to digital converter 444 receives readings from the sensor array(s) 446 and from additional sensors 450, 452, 454. For example, a current may be provided to a sensing resistor and the resultant voltage may be converted to a digital value. That digital value may be stored in a register and read out (i.e., transmitted as serial data bits, or as a bitstream) over the I2C bus. The analog to digital converter 444 may utilize parameters, for example, gain and/or offset parameters, which may be stored in registers.

In this example, there are different additional single sensors, including for example at least one of an ambient temperature sensor 450, a crack detector 452, and/or a fluid temperature sensor 454. These may sense, respectively, an ambient temperature, a structural integrity of a die on which the logic circuitry is provided, and a fluid temperature.

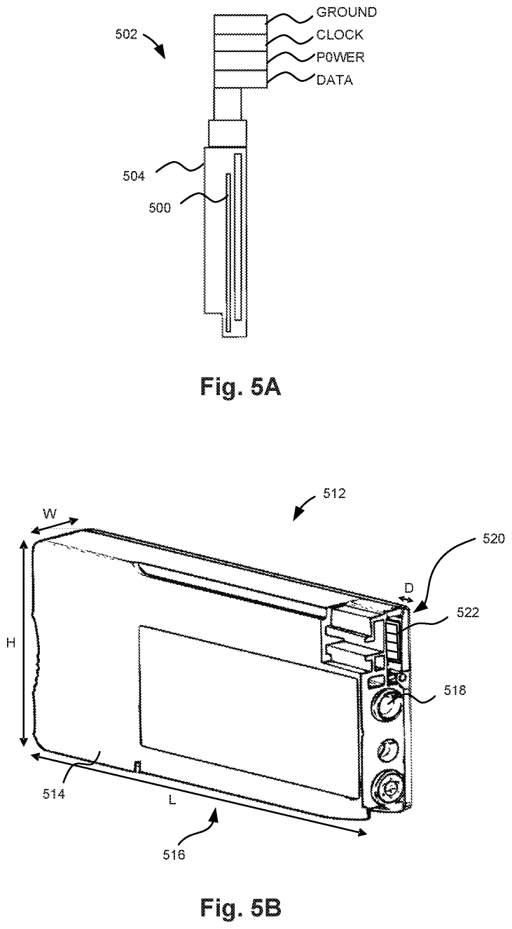

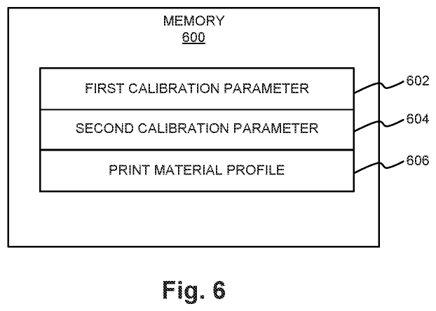

FIG. 5A illustrates an example of a possible practical arrangement of a second logic circuit embodied by a sensor assembly 500 in association with a circuitry package 502. The sensor assembly 500 may include a thin film stack and include at least one sensor array such as a fluid level sensor array. The arrangement has a high length to width aspect ratio (e.g., as measured along a substrate surface), for example being around 0.2 mm in width, for example less than 1 mm, 0.5 mm, or 0.3 mm, and around 20 mm in length, for example more than 10 mm, leading to length to width aspect ratios equal to or above approximately 20:1, 40:1, 60:1, 80:1, or 100:1. In an installed condition the length may be measured along the height. The logic circuit in this example may have a thickness of less than 1 mm, less than 0.5 mm, or less than 0.3 mm, as measured between the bottom of the (e.g., silicon) substrate and the opposite outer surface. These dimensions mean that the individual cells or sensors are small. The sensor assembly 500 may be provided on a relatively rigid carrier 504, which in this example also carries Ground, Clock, Power and Data I2C bus contacts.

FIG. 5B illustrates a perspective view of a print cartridge 512 including a logic circuitry package of any of the examples of this disclosure. The print cartridge 512 has a housing 514 that has a width W less than its height H and that has a length L or depth that is greater than the height H. A print liquid output 516 (in this example, a print agent outlet provided on the underside of the cartridge 512), an air input 518 and a recess 520 are provided in a front face of the cartridge 512. The recess 520 extends across the top of the cartridge 512 and I2C bus contacts (i.e., pads) 522 of a logic circuitry package 502 (for example, a logic circuitry package 400a-400d as described above) are provided at a side of the recess 520 against the inner wall of the side wall of the housing 514 adjacent the top and front of the housing 514. In this example, the data contact is the lowest of the contacts 522. In this example, the logic circuitry package 502 is provided against the inner side of the side wall. In some examples, the logic circuitry package 502 includes a sensor assembly as shown in FIG. 5A.

In other examples, a replaceable print apparatus component includes a logic circuitry package of any of the examples described herein, wherein the component further includes a volume of liquid. The component may have a height H that is greater than a width W and a length L that is greater than the height, the width extending between two sides. Interface pads of the package may be provided at the inner side of one of the sides facing a cut-out for a data interconnect to be inserted, the interface pads extending along a height direction near the top and front of the component, and the data pad being the bottom-most of the interface pads, the liquid and air interface of the component being provided at the front on the same vertical reference axis parallel to the height H direction wherein the vertical axis is parallel to and distanced from the axis that intersects the interface pads (i.e., the pads are partially inset from the edge by a distance D). The rest of the logic circuitry package may also be provided against the inner side.

It will be appreciated that placing logic circuitry within a print material cartridge may create challenges for the reliability of the cartridge due to the risks that electrical shorts or damage can occur to the logic circuitry during shipping and user handling, or over the life of the product.

A damaged sensor may provide inaccurate measurements, and result in inappropriate decisions by a print apparatus when evaluating the measurements. Therefore, a method may be used to verify that communications with the logic circuitry based on a specific communication sequence provide expected results. This may validate the operational health of the logic circuitry.

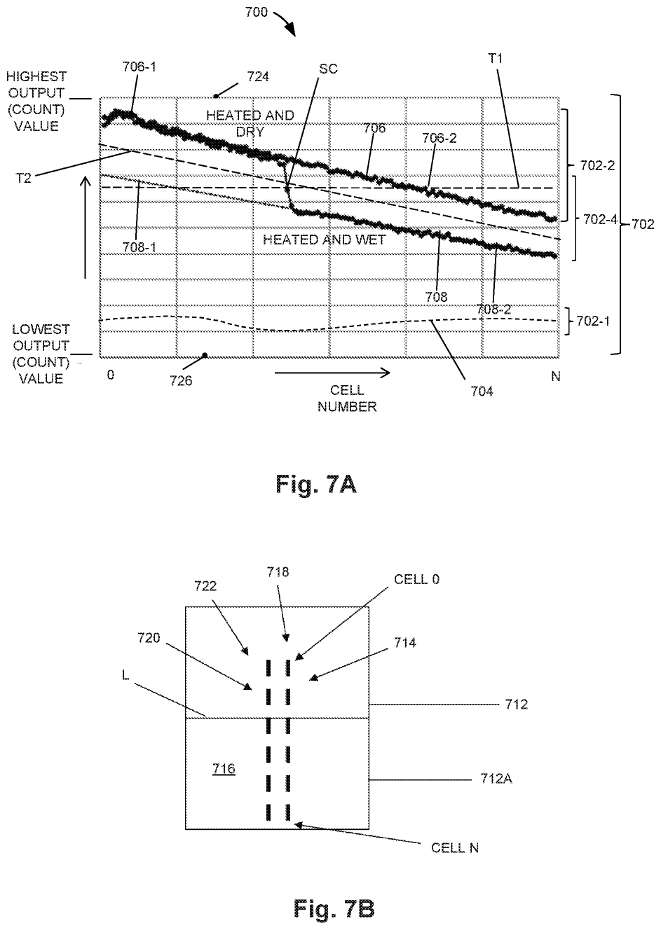

FIG. 6 illustrates one example of a memory 600 of a logic circuitry package, which may provide a part of memory 423a of logic circuitry package 400c (FIG. 4C), memory 426 of processing circuitry 424 (FIG. 4D), or memory 432 of logic circuitry package 400d (FIG. 4E). Memory 600 may store, in addition to other values previously described, a first calibration parameter 602, a second calibration parameters 604, a print material profile 606, and/or other suitable parameters for operating a logic circuitry package. In some examples, each of the values or a subset of the values stored in memory 600 may be digitally signed.

As will be described in more detail below, the first calibration parameter 602 may include a first heat time parameter specifying a first period (e.g., 180 μs) to activate a heater cell (e.g., a heater cell 416a-416f of logic circuitry package 400b of FIG. 4B), and the second calibration parameter 604 may include a second heat time parameter specifying a second period (e.g., 80 μs) less than the first period to activate a heater cell. In one example, the value of the first calibration parameter 602 is greater than two times the value of the second calibration parameter 604. In another example, a difference between the value of the first calibration parameter 602 and the value of the second calibration parameter 604 is greater than 50 μs. The first calibration parameter and the second calibration parameter may be stored as count values equal to the number of cycles of a clock signal of the logic circuitry package equivalent to the first period and the second period, respectively. The print material profile 606 may correspond to expected measurements when the first calibration parameter 602 and the second calibration parameter 604 are used to sense a print material property (e.g., film thickness over time after an agitation event).

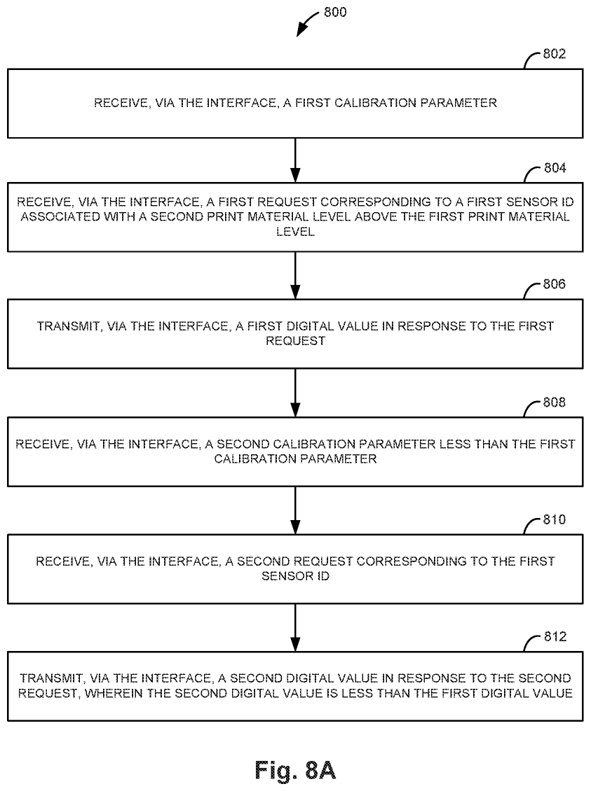

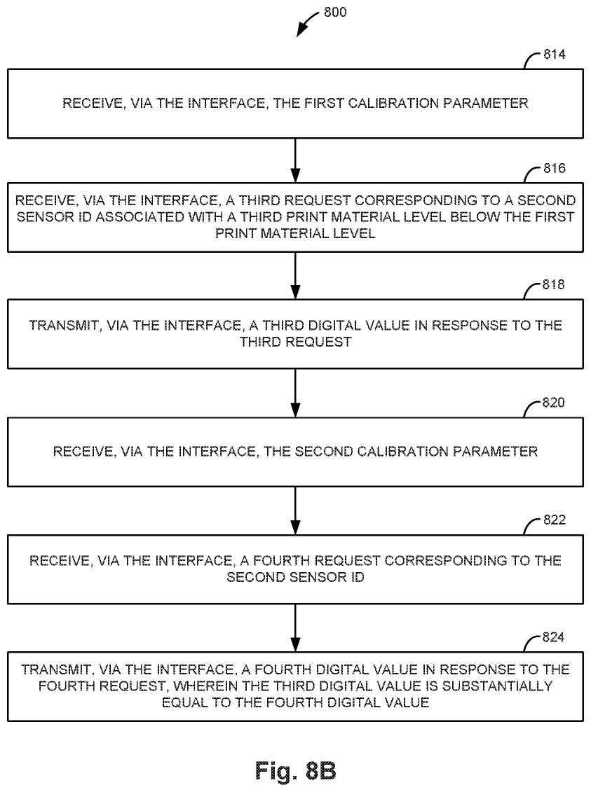

FIG. 7A is a graph 700 illustrating one example of ink level sensor readings. Graph 700 includes output count values on a vertical axis and cell numbers (or IDs) on a horizontal axis. The graph reflects a thermal response of an example thermal sensor cell array, for example to determine a print material level, such as a print liquid level, such as an ink level (e.g., print material level sensor 410 of FIG. 4B or international patent application publication No. WO2017/074342).

At installation, the printer may send a command including calibration parameters, a cell class selection (e.g., sensor ID) and a cell sub-class selection (e.g., sub-ID), and subsequently, a read request. In response, the logic circuit may identify the calibration parameters and the respective sensor cell to be selected and output the count value corresponding to the state of that selected cell. The calibration parameters may include heat parameters (e.g., heater cell identification number, heat time, power), offset parameters, gain amplifier parameters, and/or digital to analog or analog to digital conversion parameters. The logic circuit may, upon instructions, select the respective temperature sensor cell, and calibrate the output of that cell. Other calibration parameters may include heating the heaters during a certain time and adjusting a voltage input (e.g., approximately 3.3 V), for example as harvested from a power contact pad of the interface, which may calibrate the cell state.

In the illustrated example, in response to a read request, an output count value of a cell increases in correspondence with an increasing temperature, implying a lower count in unheated condition (702-1, 704) and higher in heated condition (702-2, 702-4, 706, 708). As will be explained, first output count values of sensor cells, when heated by heaters and doped in liquid, per line 708 and range 702-4, are lower than second output count values corresponding to the same cells being heated but not doped in liquid, per line 706 and range 702-2. Hence, an absence or presence of liquid at a respective cell can be sensed. The temperature sensor output may correspond to an output reading at a given point in time after or during a heat event for the corresponding heater cell, which in some examples may be calibrated using calibration logic. In one example, the temperature sensor cell is calibrated and read in conjunction with heating of the corresponding heater cells, corresponding to lines 706 and 708 and ranges 702-2 and 702-4. In another example, the sensor cells may also be read when not heated, per dashed line 704 and range 702-1.

Liquid over a temperature sensor cell may have a cooling effect. Hence, a temperature and/or a temperature decay of a wet sensor cell may be electrically measured and compared to measurements of a dry sensor cell. For example, the temperature sensor cells may include sense resistors, which have values that are read just after applying a voltage over a nearby heater resistor for a given time. For example, after activating a heater for a short period (e.g., for 40-70 microseconds), a proximate temperature sensor cell is read, for example at about 0 to 50 microseconds after the heating stopped, whereby the temperature sensor cells in liquid (per line 708) may be cooler than temperature sensor cells not covered by the liquid (per line 706), which is reflected by a measurable analog electrical state of that cell. Then, the measured analog state is converted to a digital count value. In one example, cooler cells have a lower resistance than warmer cells, which, after analog to digital conversion, results in a reduction in output count value.

The logic circuit may be configured to output a step change SC in a series of count value outputs, when a part of the sensor cells are doped in liquid. The step change SC in output count values for a cell array may correspond to certain cells being doped in liquid and other cells not being doped. For example, the logic circuit is configured to, for a certain print liquid level of a partly depleted print liquid reservoir, in response to identifying the second class parameters and series of subsequent different sub-class parameters (which in this example are associated with the temperature sensor cell array), output second count values 706-1, associated with a sub-set of the sub-class selections, on one side of a step change SC in the outputs, and first count values 708-2 that are all at least a step change SC lower than the second count values, the first count values associated with the rest of the series sub-class selections, on another side of the step change SC in the outputs. The first count values 708-2 are associated with wet cells and the second count values 706-1 are associated with dry cells whereby the step change SC may represent an approximate liquid level.

For example, to later detect that step change SC, first, the sensor cell output needs to be calibrated, for example in the factory or after print apparatus component installation. At a first calibration or read cycle, the reservoir 712A (FIG. 7B) may be full or for example at least approximately half full associated with a situation where all sensor cells 714 are covered by liquid. Hence, at installation and/or after calibration, all cells 714 may return readings corresponding to heated wet cells per full line 708, resulting in relatively smoothly varying outputs count values, for example where differences between subsequent count values are less than 5, less than 2 or less than 1, for certain operational calibration parameters. For example, a step change SC is associated with a jump of at least 10 counts, at least for certain operational calibration parameters. For example, the operational calibration parameters may be such that the output count value of heated and wet cells are in a predetermined count value sub-range 702-4 at a distance from the lowest and highest count value, for example at least 10 counts distance. For example, the “middle” sub-range 702-4 may be at least approximately 50, at least approximately 60, at least approximately 80 or at least approximately 100 count units distance from the lowest count value of the range, and at some count units distance from the highest count value of the range, for example at least 50 counts from the highest count value, for example between 60 and 200 counts. In other examples, the cells could be calibrated when dry per higher sub-range 702-2 or when not heated per lower sub-range 702-1.

If the cells of the sensor cell array are arranged vertically in the liquid reservoir 712A then the step change SC may be associated, by the print apparatus, with the liquid level, after depletion of at least part of the liquid whereby certain higher cells are dry and certain lower cells are wet. The step change SC may be detected by the print apparatus in which the sensor is installed by reading the respective cell states for each cell or for a sub-set of cells. In the above examples, a print material level is determined by relating the detected step change SC with the associated sub-class(es).

In addition to, or instead of the step change SC, a variable threshold T1, or sloped threshold T2 (both indicated in FIG. 7A), may be applied to determine which cells are dry and which are wet. The sloped threshold T2 may correspond to the slope of the different cell readings of the array which may be subject to parasitic resistance. In certain examples, the variable threshold T1 may be applied depending on what the expected print material level is, and/or what cells are expected to be dry versus wet. For either threshold T1, T2, first lower count values are below and second higher count values are above the threshold T1, T2.

FIG. 7B diagrammatically illustrates an example of a replaceable print component 712 with print material 716, and a sensor cell array 718 having sensor cells 714. Heater cells 720 of heater array 722 may be arranged alongside the sensor cells 714, which may be considered part of the sensor or part of the calibration logic. At installation, the print apparatus component 712 is filled to a point above the temperature sensor cell array 718 so that the cell array 718 is completely covered by the print material 716. In such state, all temperature cells 714 of the array 718 return first, relatively low count values, corresponding to line 708, i.e., both sub-lines 708-1 and 708-2, of FIG. 7A. Then, after some exhaustion of print material 716 (which is illustrated in FIG. 7A), when the print material level L drops to a point below the highest cell 0 of the array 718, a higher sub-set of cells (including highest cell 0) outputs second, higher count values because they are not covered by the print material, and hence, not cooled, corresponding to sub-line 706-1, while a lower sub-set of cells (including lowest cell n) may output first, lower count values, corresponding to sub-line 708-2. Correspondingly, the logic circuit is configured to output second count values above a threshold T, per line 706-1, and first count values below the threshold T, per line 708-2. The logic circuit may output intermediate count values, in the step change SC, relatively close to the threshold T1, T2, associated with certain cells that are positioned near the liquid surface, which count values are between the first and second count values.

When the print material 716 has substantially exhausted, i.e., the print material level has dropped below the lowest cell n, all cells 714 may return second, relatively high count values corresponding to the full line 706, including both 706-1 and 706-2. In one example, the slope of the lines 706, 708, representing a steady decrease of output count values of subsequent cells down the cell array 718, may be caused by parasitic resistance. A sloped threshold T2 to determine the difference between first (e.g., lower) and second (e.g., higher) count values may extend between the first and second line 708, 706, respectively, and also have such slope. In other examples, the sensor circuit is configured to, for the partially filled reservoir where a print material level extends somewhere at the sensor cell array 718, generate the step change SC so the print material level may be determined without using thresholds T1 or T2.

For example, the temperature sensor cell array 718 may include over 20, over 40, over 60, over 80, over 100 or over 120 cells (in one example, 126 cells). The cells may include thin film elements on a thin film substrate, as part of thin film circuitry. In one example, the temperature sensor cells include resistors. In one example, each temperature sensing resistor has a serpentine shape, for example to increase its length over a small area.

At a first usage of a filled replaceable print apparatus component (e.g., first customer installation), a temperature sensor cell response in heated and wet condition may be determined for calibration, because all cells may be covered by print liquid. Since it is known that the output of a dry sensor cell is higher (per line 706), the calibrated output count value for the wet cells (per line 708) should be at a certain minimum distance from the highest output count value 724 of the output count value range 702 to allow for margin for later outputs of the dry cells per line 706. For example, the output count value for wet and heated cells may be set to be in the first sub-range 702-4, whereby narrower sub-ranges can be applied by selecting certain cells. For example, one or more calibration parameters are adjusted until the output count value of at least one of the wet cells is within the sub range 702-4, for example having at least 50 or 100 counts distance from the highest output count value, for example between about 60 and 200 counts.

The calibration logic may set any of the heating power, heating time, sense time, offset function, amplifier function, and/or analog to digital and digital to analog conversion functions so that the output count values are within the operational range 702-4, at a sufficient distance from the highest output count value 724 to allow for margin for dry and heated readings, and/or at a sufficient distance from the lowest output count value 726 to allow for margin for (wet or dry) unheated readings. The calibration parameters may be adjusted until the logic circuit returns an output count value 708, first, within the wider count value range 702 at a distance from the highest and lowest output count values 724, 726, respectively, (e.g., to avoid clipping) and, second, in a narrower sub-range 702-4, for example having at least 50 or 100 counts from the highest output count value (e.g., at least 10% or at least 20% of the range distance from the ends of the range) if the output count value range is between 0 and 255, for example between 60 and 200 counts. In this example, the output count value range is set so that there is margin in the count value range for a lower output count value range 702-1 for unheated cells, for example below the 60 or 100 counts, while still being able to determine the difference between dry and wet cells.

The lower output count value range 702-1 corresponds to unheated cells and could also be used for calibration purposes or other purposes. The lower output count value range could be below an approximately middle of the output count value range (e.g., below 128), or, for example, below 100 or below 60 counts.

After setting the operational calibration parameters, the print material level may be derived by detecting a step change SC in the output count values of the series of cells 714 of the array 718, or by verifying the count values with respect to one or more thresholds T1, T2. For example, the logic circuit is configured to, in response to identifying a second class parameter associated with the print material (i.e., temperature) sensor class, and subsequently, a series of varying sub-class parameters and read requests, where the series is received at various points in time, output (a) first count values (e.g., 708-1 on line 708), associated with the sub-class parameters, and, (b) at a later point in time when more print liquid in a replaceable print component has been extracted, second count values (e.g., 706-1 on line 706), higher than the first count values, associated with the same sub-class parameters. The latter second and first count values 706 versus 708 may each be output in different read cycles in separate time durations of second address enablement. The logic circuit may be configured to, for a certain print liquid level of a partly depleted print liquid reservoir 712A (e.g., a level L extends at some point along the sensor cell array 718), in response to identifying the second class parameter and a series of subsequent different sub-class parameters, output second count values 706-1, higher than a certain threshold T1 or T2, associated with a sub-set of the sub-classes, and first count values 708-2, lower than the threshold T1 or T2, associated with the rest of the sub-classes. The latter second and first count values 706-1, 708-2 may be output in a single read cycle for example in a single time duration of the second address enablement. The latter second and first count values 706-1, 708-2 may be separated by a step change SC, in a diagram plotting on one axis the sub-class numbers and another axis the output count values (per FIG. 7A). The first count values are all at least a step change lower than the second count values. At least one third count value may be provided in the step change SC.

For example, in response to receiving the second class parameter associated with the print material sensor class, and operational calibration parameters for that class, and subsequently, a series of sub-class selections and respective read requests, the logic circuitry package may output, during depletion of the associated liquid reservoir, (i) at a first point in time, first relatively low count values for all sub-class selections of the series (e.g., line 708 including 708-1 and 708-2), (ii) at a second point in time after depletion, second relatively high count values for a sub-set of the series of sub-class selections (e.g., line 706-1) and first relatively low count values for remaining sub-class selections of the series (e.g., line 708-2), and, (iii) at a third point in time after more depletion (e.g., complete or near exhaustion), second relatively high count values for all sub-class selections of the series (e.g., line 706 including 706-1 and 706-2). The respective first, second and third condition (as indicated by roman numerals i, ii and iii, respectively) are associated with a measure of depletion of print liquid 716 during the lifetime of a replaceable print component 712. The sub-class IDs corresponding to the step change SC can be determined which in turn allows for determining the print material level. In use, the respective transitions between the first, second and third condition (i, ii, iii) are accompanied by a change in a count field in a memory of the package (e.g., memory 432 of FIG. 4E), which count field is associated with a print material level by a print apparatus and may be regularly updated by the print apparatus between or during print jobs, for example based on printed drop count or printed pages count.

In certain examples, the sensor circuit 718, 722 may extend from near a gravitational bottom upwards, at least in a normal operational orientation, but not reach the complete height of the reservoir 712A. Hence, the logic circuit is configured to generate first, relatively low count values 708 during a substantial part of the lifetime, per roman i above. In certain alternative embodiments, the logic circuit may return only first count values, per line 708 and sub-range 702-4, in response to the second class parameters and subsequent sub-class parameters and certain operational calibration parameters, at least until a value in the print material level field reaches a value that the print apparatus logic circuit associated with a level that is above the second sensor cells 718.

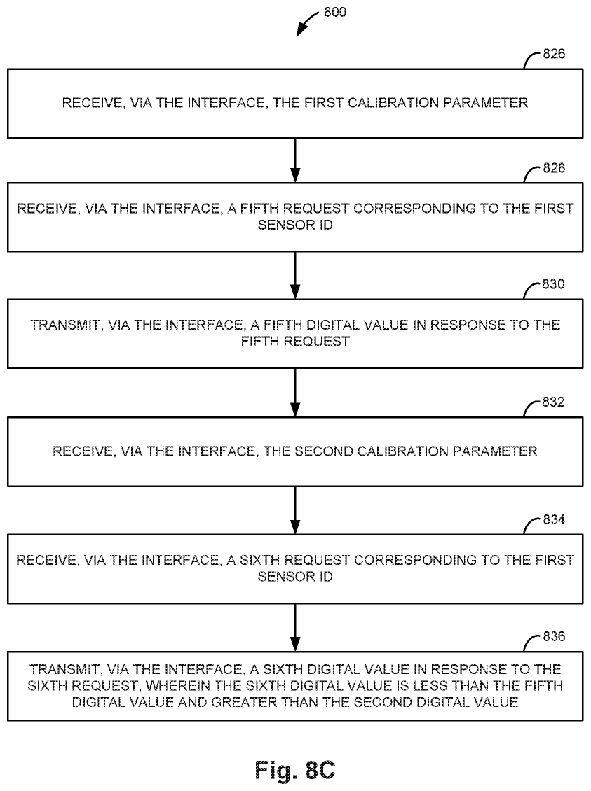

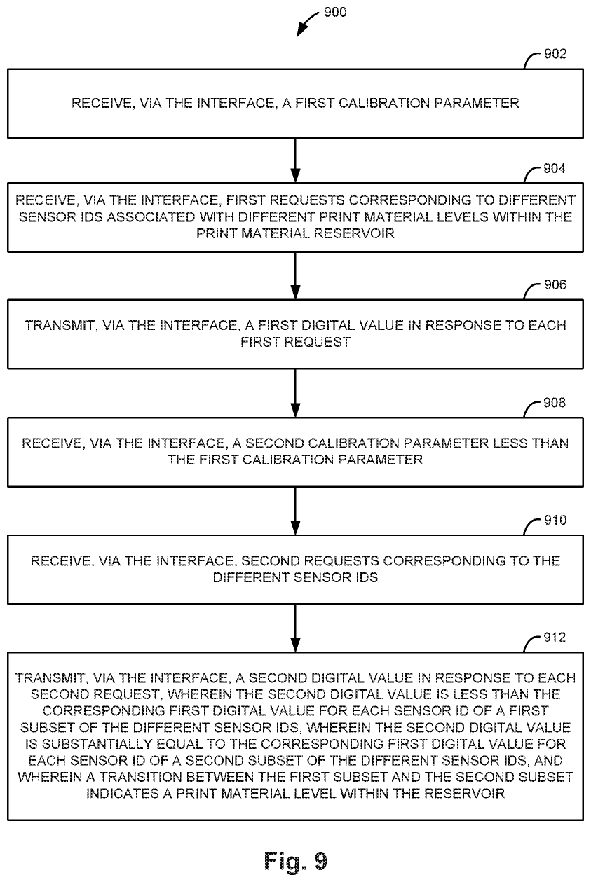

While FIGS. 7A and 7B described using an ink level sensor (e.g., 718 and 722 of FIG. 7B) to determine an ink level within a reservoir of a print apparatus component, the ink level sensor may also be used to determine a film thickness of the ink on the sensor as will be described below with reference to FIGS. 8A-9. The film thickness of the ink on the surface of a sensor cell provides information beyond whether a sensor cell is simply wet or dry, and may be used to differentiate bulk ink from false triggers such as air bubbles, stranded ink droplets, or residual ink draining on the sensor after component agitation. Using this secondary measurement technique may enhance the first order ink level sensor wet/dry determination previously described and produce a higher confidence ink level decision.

The logic circuitry package may include a “Trust” metric. This Trust metric represents how often the ink level sensor and algorithm correctly determine the ink level of a component versus how often the incorrect ink level is determined. If too many incorrect ink level determinations are made, the Trust score decreases, and the print apparatus component may be rejected by a printer in the field. The logic circuitry package should perform with a high Trust score by avoiding false triggers.

During a print job, the scanning carriage motion may disturb the ink level in the print apparatus component. The scanning motion strands residual ink on the ink level sensing (ILS) die, generates air bubbles, splashes droplets of ink onto the sensor, creates froth inside the reservoir, etc. Each of these may cause the sensor to appear wet at a given location during the ILS measurement, resulting in what appears to be multiple ink levels within the component. This may be confusing to an ILS algorithm, and result in incorrect determination of the ink level, negatively affecting the Trust score.

The bulk fluid (i.e., below the true fluid level in the supply), however, has an effectively infinitely deep thermal response, whereas residual fluid on the sensor surface has a finite thermal depth and a thermal ILS response that may be used to differentiate the residual fluid from the bulk fluid. Whereas the ILS method described with reference to FIGS. 7A and 7B uses a single heat pulse event to obtain a single thermal response profile for the entire die, the Thermal Depth methodology described below uses a measurement sequence involving a series of varying length heating events and precisely timed measurements to interrogate the depth of the fluid in contact with the sensor, one thermal layer at a time. The ILS Thermal Depth method uses multiple ILS snapshots, each sensing further into the depth of a fluid in contact with the sensor, to interrogate the fluidic thickness and differentiate between residual fluid, stranded ink, and air bubbles versus the bulk fluid (i.e., the true ink level).

In one example, after scanning carriage motion, residual fluid on the sensor above the true ink level will have a finite thickness. This thin film of fluid is able to absorb all heat input when exposed to short ILS heating events. Therefore this residual fluid looks wet to the ILS response. However, when that same thin film is exposed to longer heating events, the thin film of fluid becomes thermally saturated resulting in a thermal response that looks more like a dry sensor.

Because this residual ink is not static, but slowly moving as the fluid settles in the component along the sensor, the fluid thin film thickness changes over time, typically on the order of seconds to several minutes. By using a number of heating event times at each measurement window, and repeated over many seconds to minutes, the dynamic fluid thin film response can be tracked. The varying thermal depth response versus time may help determine the true ink level after several minutes, rather than waiting a longer time (e.g., 15 minutes) to allow the ink to fully settle.

FIGS. 8A-8C are flow diagrams illustrating example methods 800 that may be carried out by a logic circuitry package, such as logic circuitry package 400a-400d, or by processing circuitry 424. In this example, there is a print material within the print material reservoir that has a first print material level (e.g., level L within reservoir 712A of FIG. 7B). As illustrated in FIG. 8A, at 802 at least one logic circuit of the logic circuitry package may receive, via the interface, a first calibration parameter (e.g., first calibration parameter 602 of FIG. 6). At 804, the at least one logic circuit may receive, via the interface, a first request corresponding to a first sensor ID associated with a second print material level above the first print material level. For example, the first request may correspond to a sensor cell 714 above level L of FIG. 7B. At 806, the at least one logic circuit may transmit, via the interface, a first digital value (e.g., output count) in response to the first request. At 808, the at least one logic circuit may receive, via the interface, a second calibration parameter (e.g., second calibration parameter 604 of FIG. 6) less than the first calibration parameter. At 810, the at least one logic circuit may receive, via the interface, a second request corresponding to the first sensor ID. At 812, the at least one logic circuit may transmit, via the interface, a second digital value in response to the second request. The second digital value is less than the first digital value. The second digital value is less than the first digital value since above the bulk ink level, the output count varies based on the first and second calibration parameters. In one example, a difference between the first digital value and the second digital value corresponds to a thickness of a print material film at the second print material level.

The first calibration parameter may include a first heat time parameter and the second calibration parameter may include a second heat time parameter. The first heat time parameter may include a first period to activate a heater cell corresponding to the first sensor ID in response to the first request and the second heat time parameter may include a second period less than the first period to activate the heater cell corresponding to the first sensor ID in response to the second request. In one example, the first heat time parameter is greater than two times the second heat time parameter. In another example, a difference between the first heat time parameter and the second heat time parameter is greater than 50 μs. The first digital value and the second digital value may correspond to a temperature of a temperature sensor cell corresponding to the first sensor ID.

As illustrated in FIG. 8B, at 814 the at least one logic circuit may further receive, via the interface, the first calibration parameter. At 816, the at least one logic circuit may receive, via the interface, a third request corresponding to a second sensor ID associated with a third print material level below the first print material level. At 818, the at least one logic circuit may transmit, via the interface, a third digital value in response to the third request. At 820, the at least one logic circuit may receive, via the interface, the second calibration parameter. At 822, the at least one logic circuit may receive, via the interface, a fourth request corresponding to the second sensor ID. At 824, the at least one logic circuit may transmit, via the interface, a fourth digital value in response to the fourth request. The third digital value is substantially equal to the fourth digital value. The third digital value is substantially equal to the fourth digital value since below the bulk ink level, the output count does not vary based on the first and second calibration parameters.

As illustrated in FIG. 8C, at 826 the at least one logic circuit may further receive, via the interface, the first calibration parameter. At 828, the at least one logic circuit may receive, via the interface, a fifth request corresponding to the first sensor ID. At 830, the at least one logic circuit may transmit, via the interface, a fifth digital value in response to the fifth request. At 832, the at least one logic circuit may receive, via the interface, the second calibration parameter. At 834, the at least one logic circuit may receive, via the interface, a sixth request corresponding to the first sensor ID. At 836, the at least one logic circuit may transmit, via the interface, a sixth digital value in response to the sixth request. The sixth digital value is less than the fifth digital value and greater than the second digital value.

The sixth digital value is less than the fifth digital value and greater than the second digital value since above the bulk ink level, the output count varies based on the first and second calibration parameters but since some of the ink above the bulk ink level has drained since the first and second requests, the fifth digital value is greater than the second digital value. The magnitude of the difference between readings using the first and second calibration parameters above the bulk ink level changes over time as the ink drains and the thin film becomes thinner. Over the first several minutes of ink drainage, this difference could be tracked to more confidently determine films versus bulk fluid and the resulting ink level position that exists at their convergence.

FIG. 9 is a flow diagram illustrating other example method 900 that may be carried out by a logic circuitry package, such as logic circuitry package 400a-400d, or by processing circuitry 424. At 902, the at least one logic circuit may receive, via the interface, a first calibration parameter (e.g., first calibration parameter 602 of FIG. 6). At 904, the at least one logic circuit may receive, via the interface, first requests corresponding to different sensor IDs associated with different print material levels within the print material reservoir. At 906, the at least one logic circuit may transmit, via the interface, a first digital value (i.e., output count) in response to each first request. At 908, the at least one logic circuit may receive, via the interface, a second calibration parameter (e.g., second calibration parameter 604 of FIG. 6) less than the first calibration parameter. At 910, the at least one logic circuit may receive, via the interface, second requests corresponding to the different sensor IDs. At 912, the at least one logic circuit may transmit, via the interface, a second digital value in response to each second request. The second digital value is less than the corresponding first digital value for each sensor ID of a first subset of the different sensor IDs (e.g., for sensor cells above the bulk ink level). The second digital value is substantially equal to the corresponding first digital value for each sensor ID of a second subset of the different sensor IDs (e.g., for sensors cells below the bulk ink level). A transition between the first subset and the second subset indicates a print material level within the reservoir.

In one example, the first calibration parameter may include a first heat time parameter and the second calibration parameter may include a second heat time parameter. The first heat time parameter may include a first period to activate each heater cell in response to a corresponding first request and the second heat time parameter may include a second period less than the first period to activate each heater cell in response to a corresponding second request. In one example, the first heat time parameter is greater than two times the second heat time parameter. In another example, a difference between the first heat time parameter and the second heat time parameter is greater than 50 μs. Each first digital value and each second digital value may correspond to a temperature of a corresponding temperature sensor cell.

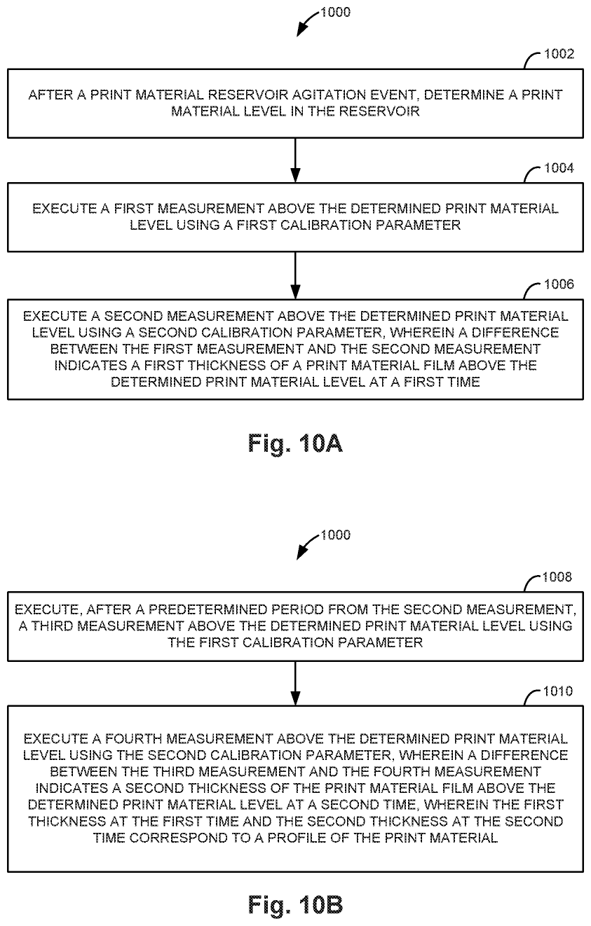

While FIGS. 8A-9 described reducing or eliminating false readings from an ink level sensor by taking reading using first and second calibration parameters to determine an ink level within a reservoir of a print apparatus component, the ink level sensor may also be used to determine a property of the ink within the reservoir as will be described below with reference to FIGS. 10A and 10B. When the print apparatus component is sufficiently agitated, such as due to scanning carriage motion, the ink may coat the ink level sensor above the bulk ink level with a film of ink. The film will have an initial thickness, and over time the thickness will diminish, eventually reaching a thickness of zero. Different inks may be differentiated by observing the thickness verses time (TVT) profile of the ink film following an agitation event. The methods described below use the ink level sensor to observe the ink's TVT profile and thereby enable differentiation between inks that have sufficiently differing TVT profiles.

FIGS. 10A and 10B are flow diagrams illustrating other example methods 1000 that may be carried out by a logic circuitry package, such as logic circuitry package 400a-400d, or by processing circuitry 424. As illustrated in FIG. 10, at 1002 the at least one logic circuit may after a print material reservoir agitation event, determine a print material level in the reservoir (e.g., as described above with reference to FIGS. 7A-7B and 9). At 1004, the at least one logic circuit may execute a first measurement (e.g., a heater cell heating event followed by a corresponding sensor cell reading as previously described) above the determined print material level using a first calibration parameter (e.g., first calibration parameter 602 of FIG. 6). At 1006, the at least one logic circuit may execute a second measurement above the determined print material level using a second calibration parameter (e.g., second calibration parameter 604 of FIG. 6). A difference between the first measurement and the second measurement indicates a first thickness of a print material film above the determined print material level at a first time.

As illustrated in FIG. 10B at 1008 the at least one logic circuit may further execute, after a predetermined period from the second measurement, a third measurement above the determined print material level using the first calibration parameter. At 1010, the at least one logic circuit may further execute a fourth measurement above the determined print material level using the second calibration parameter. A difference between the third measurement and the fourth measurement indicates a second thickness of the print material film above the determined print material level at a second time. The first thickness at the first time and the second thickness at the second time correspond to a profile (e.g., print material profile 606 of FIG. 6) of the print material.

In one example, the first calibration parameter may include a first heat time parameter and the second calibration parameter may include a second heat time parameter. The first heat time parameter may include a first period to activate a heater cell above the determined print material level for the first measurement and the second heat time parameter may include a second period less than the first period to activate the heater cell above the determined print material level for the second measurement. The first and second measurements may correspond to a temperature of a temperature sensor cell above the determined print material level.

FIG. 11 illustrates another example of a logic circuitry package 1100. FIG. 11 illustrates how the logic circuitry package 1100 may generate a digital output (e.g., output count value) based on inputs including a sensor ID and calibration parameters (e.g., first and second calibration parameters) sent digitally by the print apparatus. Logic circuitry package 1100 includes a logic circuit with a processor 1102 communicatively coupled to a memory 1104. Memory 1104 may store look up table(s) and/or list(s) 1106 and/or algorithm(s) 1108. Logic circuitry package 1100 may also include any of the features of logic circuitry packages 400a-400d or processing circuitry 424 as previously described.

For example, the logic circuitry package 1100 may include at least one sensor 1110, or multiple sensors of different types. The logic circuit may be configured to consult a respective sensor 1110, in combination with the LUT(s)/list(s) 1106 and/or algorithm(s) 1108, based on the sensor ID and calibration parameters, to generate the digital output. The at least one sensor 1110 may include a sensor to detect an ink level within a print material reservoir of a replaceable print component, and/or a sensor to detect an approximate temperature, and/or other sensors. The logic circuitry package 1100 may include a plurality of sensors of different types, for example, at least two sensors of different types, wherein the logic circuit may be configured to select and consult one of the sensors based on the sensor ID, and output a digital value based on a signal of the selected sensor.

Different sets of all the parameters are related to the different output count values as already explained above. The output count values may be generated using the LUT(s) and or list(s) 1106 and/or algorithm(s) 1108 whereby the parameters may be used as input. In addition, a signal of at least one sensor 1110 may be consulted as input for the LUT. In this case, the output count values may be digitally generated, rather than obtained from analog sensor measurements. For example, logic circuitry package 1100 may implement method 800 of FIGS. 8A-8C, method 900 of FIG. 9, and/or method 1000 of FIGS. 10A and 10B without converting any actual sensor measurements. In another example, analog sensor measurements may be used to thereafter digitally generate the output count value, not necessarily directly converted, but rather, using a LUT, list or algorithm, whereby the sensor signal is used to choose a portion or function of the LUT, list or algorithm. The example logic circuitry package 1100 may be used as an alternative to the complex thin film sensor arrays addressed elsewhere in this disclosure. The example logic circuitry package 1100 may be configured to generate outputs that are validated by the same print apparatus logic circuit designed to be compatible with the complex sensor array packages. The alternative package 1100 may be cheaper or simpler to manufacture, or simply be used as an alternative to the earlier mentioned packages, for example to facilitate printing and validation by the print apparatus.

In one example, the logic circuitry packages described herein mainly include hardwired routings, connections, and interfaces between different components. In another example, the logic circuitry packages may also include at least one wireless connection, wireless communication path, or wireless interface, for internal and/or external signaling, whereby a wirelessly connected element may be considered as included in the logic circuitry package and/or replaceable component. For example, certain sensors may be wireless connected to communicate wirelessly to the logic circuit/sensor circuit. For example, sensors such as pressure sensors and/or print material level sensors may communicate wirelessly with other portions of the logic circuit. These elements, that communicate wirelessly with the rest of the logic circuit, may be considered part of the logic circuit or logic circuitry package. Also, the external interface of the logic circuitry package, to communicate with the print apparatus logic circuit, may include a wireless interface. Also, while reference may be made to power routings, power interfaces, or charging or powering certain cells, certain examples of this disclosure may include a power source such as a battery or a power harvesting source that may harvest power from data or clock signals.

Certain example circuits of this disclosure relate to outputs that vary in a certain way in response to certain commands, events and/or states. It is also explained that, unless calibrated in advance, responses to these same events and/or states may be “clipped”, for example so that they cannot be characterized or are not relatable to these commands, events and/or states. For these example circuits where the output needs to be calibrated to obtain the characterizable or relatable output, it should be understood that also before required calibration (or installation) occurred these circuits are in fact already “configured” to provide for the characterizable output, that is, all means are present to provide for the characterizable output, even where calibration is yet to occur. It may be a matter of choice to calibrate a logic circuit during manufacture and/or during customer installation and/or during printing, but this does not take away that the same circuit is already “configured” to function in the calibrated state. For example, when sensors are mounted to a reservoir wall, certain strains in that wall over the lifetime of the component may vary and may be difficult to predict while at the same time these unpredictable strains affect the output of the logic circuit. Different other circumstances such as conductivity of the print material, different packaging, in-assembly-line-mounting, etc. may also influence how the logic circuit responds to commands/events/states so that a choice may be made to calibrate at or after a first customer installation. In any of these and other examples, it is advantageous to determine (operational) calibration parameters in-situ, after first customer installation and/or between print jobs, whereby, again, these should be considered as already adapted to function in a calibrated state. Certain alternative (at least partly) “virtual” embodiments discussed in this disclosure may operate with LUTs or algorithms, which may similarly generate, before calibration or installation, clipped values, and after calibration or installation, characterizable values whereby such alternative embodiment, should also be considered as already configured or adapted to provide for the characterizable output, even before calibration/installation.

In one example, the logic circuitry package outputs count values in response to read requests. In many examples, the output of count values is discussed. In certain examples, each separate count value is output in response to each read request. In another example, a logic circuit is configured to output a series or plurality of count values in response to a single read request. In other examples, output may be generated without a read request.

Each of the logic circuitry packages 400a-400d, 1100 described herein may have any feature of any other logic circuitry packages 400a-400d, 1100 described herein or of the processing circuitry 424. Any logic circuitry packages 400a-400d, 1100 or the processing circuitry 424 may be configured to carry out at least one method block of the methods described herein. Any first logic circuit may have any attribute of any second logic circuit, and vice versa.

Examples in the present disclosure can be provided as methods, systems or machine readable instructions, such as any combination of software, hardware, firmware or the like. Such machine readable instructions may be included on a machine readable storage medium (including but not limited to EEPROM, PROM, flash memory, disc storage, CD-ROM, optical storage, etc.) having machine readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that at least some blocks in the flow charts and block diagrams, as well as combinations thereof can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry may execute the machine readable instructions. Thus, functional modules of the apparatus and devices (for example, logic circuitry and/or controllers) may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a machine readable storage (e.g., a tangible machine readable medium) that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

The word “comprising” does not exclude the presence of elements other than those listed in a claim, “a” or “an” does not exclude a plurality, and a single processor or other unit may fulfill the functions of several units recited in the claims.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1-30. (canceled)

31. A replaceable print apparatus component comprising:
a print material reservoir;
a print material within the reservoir and having a first print material level; and
a logic circuitry package comprising an interface to communicate with a print apparatus logic circuit, and at least one logic circuit configured to:
receive, via the interface, a first calibration parameter;
receive, via the interface, a first request corresponding to a first sensor ID associated with a second print material level above the first print material level;
transmit, via the interface, a first digital value in response to the first request;
receive, via the interface, a second calibration parameter less than the first calibration parameter;
receive, via the interface, a second request corresponding to the first sensor ID; and
transmit, via the interface, a second digital value in response to the second request,
wherein the second digital value is less than the first digital value.

32. The replaceable print apparatus component of claim 31, wherein the at least one logic circuit is configured to:
receive, via the interface, the first calibration parameter;
receive, via the interface, a third request corresponding to a second sensor ID associated with a third print material level below the first print material level;
transmit, via the interface, a third digital value in response to the third request;
receive, via the interface, the second calibration parameter;
receive, via the interface, a fourth request corresponding to the second sensor ID; and
transmit, via the interface, a fourth digital value in response to the fourth request,
wherein the third digital value is substantially equal to the fourth digital value.

33. The replaceable print apparatus component of claim 31, wherein the at least one logic circuit is configured to, after a predetermined period from receiving the second request:
receive, via the interface, the first calibration parameter;
receive, via the interface, a fifth request corresponding to the first sensor ID;
transmit, via the interface, a fifth digital value in response to the fifth request;
receive, via the interface, the second calibration parameter;
receive, via the interface, a sixth request corresponding to the first sensor ID; and
transmit, via the interface, a sixth digital value in response to the sixth request,
wherein the sixth digital value is less than the fifth digital value and greater than the second digital value.

34. The replaceable print apparatus component of claim 31, wherein a difference between the first digital value and the second digital value corresponds to a thickness of a print material film at the second print material level.

35. The replaceable print apparatus component of claim 31, further comprising:
a sensor to determine the print material level, wherein the sensor comprises a plurality of heater cells and a corresponding plurality of temperature sensor cells.

36. The replaceable print apparatus component of claim 31, wherein the at least one logic circuit comprises a memory storing the first calibration parameter and the second calibration parameter, wherein the memory stores digitally signed data comprising the first calibration parameter and the second calibration parameter.

37. The replaceable print apparatus component of claim 35, wherein the first calibration parameter comprises a first heat time parameter and the second calibration parameter comprises a second heat time parameter.

38. The replaceable print apparatus component of claim 37, wherein the first heat time parameter comprises a first period to activate a heater cell corresponding to the first sensor ID in response to the first request and the second heat time parameter comprises a second period less than the first period to activate the heater cell corresponding to the first sensor ID in response to the second request.

39. The replaceable print apparatus component of claim 35, wherein the first digital value and the second digital value correspond to a temperature of a temperature sensor cell corresponding to the first sensor ID.

40. A replaceable print apparatus component comprising:
a print material reservoir:
a print material within the reservoir; and
a logic circuitry package comprising an interface to communicate with a print apparatus logic circuit, and at least one logic circuit configured to:
receive, via the interface, a first calibration parameter;
receive, via the interface, first requests corresponding to different sensor IDs associated with different print material levels within the print material reservoir;
transmit, via the interface, a first digital value in response to each first request;
receive, via the interface, a second calibration parameter less than the first calibration parameter;
receive, via the interface, second requests corresponding to the different sensor IDs; and
transmit, via the interface, a second digital value in response to each second request,
wherein the second digital value is less than the corresponding first digital value for each sensor ID of a first subset of the different sensor IDs,
wherein the second digital value is substantially equal to the corresponding first digital value for each sensor ID of a second subset of the different sensor IDs, and
wherein a transition between the first subset and the second subset indicates a print material level within the reservoir.

41. The replaceable print apparatus component of claim 40, further comprising:
a sensor corresponding to the different sensor IDs, wherein the sensor comprises a plurality of heater cells and an associated plurality of temperature sensor cells, each heater cell and associated temperature sensor cell corresponding to a sensor ID of the different sensor IDs.

42. The replaceable print apparatus component of claim 41, wherein the first calibration parameter comprises a first heat time parameter and the second calibration parameter comprises a second heat time parameter.

43. The replaceable print apparatus component of claim 42, wherein the first heat time parameter comprises a first period to activate each heater cell in response to a corresponding first request and the second heat time parameter comprises a second period less than the first period to activate each heater cell in response to a corresponding second request.

44. The replaceable print apparatus component of claims 41, wherein each first digital value and each second digital value correspond to a temperature of a corresponding temperature sensor cell.

45. A replaceable print apparatus component comprising:
a print material reservoir:
a print material within the reservoir; and
a logic circuitry package comprising an interface to communicate with a print apparatus logic circuit, and at least one logic circuit configured to:
after a print material reservoir agitation event, determine a print material level in the reservoir;
execute a first measurement above the determined print material level using a first calibration parameter; and
execute a second measurement above the determined print material level using a second calibration parameter, wherein a difference between the first measurement and the second measurement indicates a first thickness of a print material film above the determined print material level at a first time.

46. The replaceable print apparatus component of claim 45, wherein the at least one logic circuit is further configured to:
execute, after a predetermined period from the second measurement, a third measurement above the determined print material level using the first calibration parameter; and
execute a fourth measurement above the determined print material level using the second calibration parameter, wherein a difference between the third measurement and the fourth measurement indicates a second thickness of the print material film above the determined print material level at a second time,
wherein the first thickness at the first time and the second thickness at the second time correspond to a profile of the print material.

47. The replaceable print apparatus component of claim 46, wherein the at least one logic circuit comprises a memory storing the profile of the print material, wherein the memory stores digitally signed data comprising the profile of the print material.

48. The replaceable print apparatus component of claims 45, further comprising:
a sensor to determine the print material level in the reservoir, wherein the sensor comprises a plurality of heater cells and a corresponding plurality of temperature sensor cells.

49. The replaceable print apparatus component of claim 48, wherein the first calibration parameter comprises a first heat time parameter and the second calibration parameter comprises a second heat time parameter.

50. The replaceable print apparatus component of claim 49, wherein the first heat time parameter comprises a first period to activate a heater cell above the determined print material level for the first measurement and the second heat time parameter comprises a second period less than the first period to activate the heater cell above the determined print material level for the second measurement.

51. The replaceable print apparatus component of claim 48, wherein the first and second measurements correspond to a temperature of a temperature sensor cell above the determined print material level.
